(19) United States
(12) Patent Application Publication
(10) Pub. No.: US 2025/0079510 A1
(43) Pub. Date: Mar. 6, 2025

(54) ANODE ASSEMBLY COMPRISING SOLID ELECTROLYTE LAYER DIRECTLY COATED ON ANODE LAYER AND ALL SOLID STATE BATTERY COMPRISING SAME

(71) Applicant: Factorial Inc., Woburn, MA (US)

(72) Inventors: Fang Hao, Andover, MA (US); Daniel Wakaba, Lawrence, MA (US); Hyun Seok Kim, Lexington, MA (US); Minh Nguyen, Lowell, MA (US); Joanna Burdynska, Woburn, MA (US)

(21) Appl. No.: 18/814,764

(22) Filed: Aug. 26, 2024

Related U.S. Application Data
(60) Provisional application No. 63/580,026, filed on Sep. 1, 2023.

(51) Int. Cl. H01M 10/0562; H01M 4/02; H01M 4/36; H01M 4/62

(52) U.S. Cl. CPC H01M 10/0562; H01M 4/366; H01M 4/625; H01M 4/626; H01M 2004/027; H01M 2300/008

(57) ABSTRACT

Disclosed is an anode assembly comprising an anode layer and a solid electrolyte layer prepared by directly coating a slurry comprising a solid electrolyte and a binder on the anode layer. The interfacial resistance between the anode layer and the solid electrolyte membrane is lower than that of an assembly prepared without direct coating. In one embodiment, the solid electrolyte is a sulfide electrolyte. In one embodiment, the binder is a nonfibrillizable binder. In one embodiment, the electrolyte membrane does not comprise a scaffold layer such as non-woven fabric.

### CROSS-REFERENCE

The present application claims priority of U.S. Ser. No. 63/580,026, filed Sep. 1, 2023, the entire content of which is incorporated herein by reference into this application.

### FIELD

Disclosed are an anode assembly comprising an anode layer and a solid electrolyte layer directly coated on the anode layer, and an electrochemical device comprising the anode assembly.

### BACKGROUND

All-solid-state batteries (ASSBs) are being extensively studied due to their better safety and higher energy density in comparison to conventional lithium-ion batteries which are based on organic liquid electrolytes. ASSBs include a solid electrolyte (SE). And an SE layer is usually made of inorganic oxide or sulfide electrolyte and used as substitute for the conventional liquid electrolyte interposed between cathode and anode. The SE layer functions as both electrolyte and separator. In general, an electrode assembly is prepared by laminating an electrolyte layer on a layer of an electrode such as an anode. Due to the relatively high resistance of the solid-solid interface therebetween, an external compression is usually applied during the stacking process and/or during operation. Thus, there remains a need for electrode assemblies with improved interfacial resistance and methods for preparing the same.

### SUMMARY

The present disclosure provides an anode assembly comprising an anode layer and a solid electrolyte layer prepared by directly coating a slurry comprising a solid electrolyte to the anode layer. In some embodiments, the anode assembly exhibits an interfacial resistance of at least 10% lower than that of an assembly prepared without direct coating. In some embodiment, the solid electrolyte is a sulfide solid electrolyte. In some embodiments, the slurry further comprises a binder. In some embodiments, the slurry further comprises a solvent. In some embodiments, the electrolyte membrane does not comprise a scaffold layer such as non-woven fabric.

The following terms shall be used to describe the present disclosure. In the absence of a specific definition set forth herein, the terms used to describe the present disclosure shall be given their common meaning as understood by those of ordinary skill in the art.

An electrolyte layer (alternatively, electrolyte membrane or electrolyte film) refers to a thin structure that allows transportation or flow of ions and prevents electronic contact between cathode and anode. An electrolyte layer has a typical thickness in a range from 5 μm to 300 μm.

A free-standing electrolyte layer refers to an electrolyte layer that does not contain a scaffold layer and can be peeled from a base after formation without cracking or breaking.

A scaffold layer refers to a mechanical support layer that is impregnated with an electrolyte. An example of a scaffold layer includes a non-woven substrate with self-supporting property, which is capable of physically sustaining its own membranes without a scaffold layer, which may be a porous substrate. In some embodiments, scaffold layer is alternatively referred as mechanical support layer, mechanical scaffold layer, or support layer.

In some embodiments, the anode layer comprises an anode protective layer (alternatively, anode sublayer or anode interlayer), an optional anode active material layer and an anode current collector. In some embodiments, an anode protective layer is a layer or sublayer disposed between the SE layer and anode active material layer or anode current collector. Without wishing to be bound by any theory, such anode protective layer may protect the anode layer, SE layer or both.

### BRIEF DESCRIPTION OF THE FIGURES

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1 illustrates a typical configuration of an all-solid state battery (ASSB).

FIG. 2 shows XRD patterns of representative solid electrolyte powders according to some embodiments of the present disclosure.

FIG. 3A shows a cross-section view of an anode assembly comprising an anode layer and a solid electrolyte layer with a non-woven fabric.

FIG. 3B shows a cross-section view of an anode assembly comprising an anode layer and a free-standing solid electrolyte layer without a non-woven fabric.

FIG. 3C shows a cross-section view of an anode assembly comprising an anode layer and a solid electrolyte directed coated onto the anode layer according to one embodiment of the present disclosure.

FIGS. 4A, 4B and 4C show the specific capacities, capacity retention rates and coulombic efficiencies of cells according to some embodiments of the present disclosure, respectively.

### DETAILED DESCRIPTION

Disclosed is an anode assembly comprising an anode layer and a solid electrolyte layer prepared by directly coating a slurry comprising a solid electrolyte to at least one surface of the anode layer. In some embodiments, the anode assembly exhibits an interfacial resistance of at least 10% lower than that of an assembly prepared without direct coating. In some embodiments, the solid electrolyte is a sulfide solid electrolyte. In some embodiments, the slurry further comprises a binder. In some embodiments, the slurry further comprises a solvent. In some embodiments, the electrolyte membrane does not comprise a scaffold layer such as non-woven fabric.

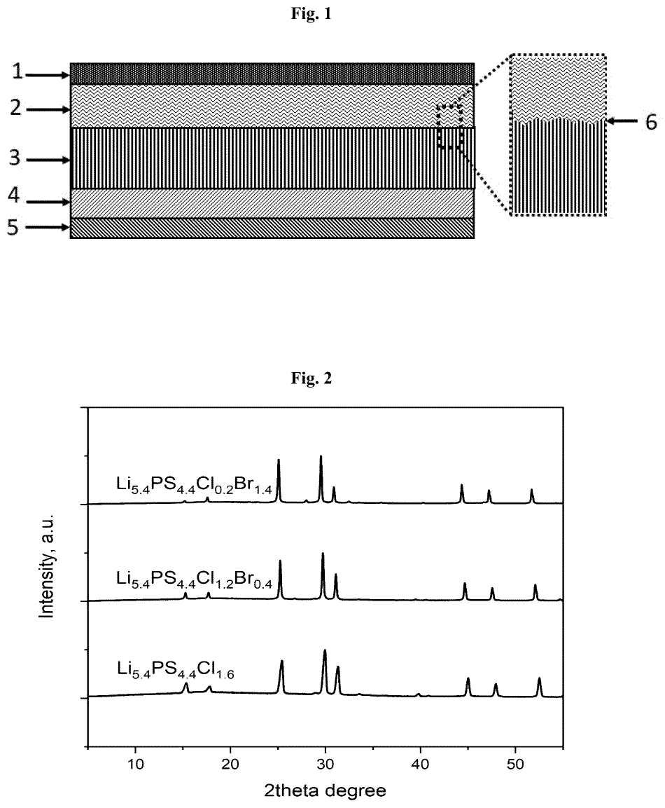

A cross-sectional view of an ASSB is shown in FIG. 1. Such ASSB comprises an anode current collector (1), an anode layer (2), a solid electrolyte (SE) layer (3), a cathode active material layer (4), and a cathode current collector (5). The interface (6) between the SE layer and the anode layer usually exhibits a high interfacial resistance due to the poor contact. When laminating a solid electrolyte layer (3) (either a free-standing electrolyte layer or an electrolyte layer with a scaffold) on an anode layer (2), some voids and/or gaps are formed on the interface (6). The existence of such voids and gaps may lead to a relatively higher interfacial resistance and deteriorate the overall performance of the battery. In some embodiments, the anode layer (2) comprises an anode protective layer (alternatively, anode sublayer or anode interlayer) and an anode active material layer. In some embodiments, the anode layer (2) comprises an anode protective layer without any anode active material layer. In some embodiments, the anode layer (2) comprises an anode active material layer without any anode protective layer. In some embodiments, an anode protective layer is a layer or sublayer disposed between the SE layer and anode active material layer or anode current collector. Without wishing to be bound by any theory, such anode protective layer may protect the anode layer, SE layer or both.

To address at least one of the challenges as described here, the present disclosure provides an anode assembly comprising an anode layer and a solid electrolyte layer prepared by directly coating a slurry comprising a solid electrolyte to at least one surface of the anode layer. By such direct coating, the SE/anode interface exhibits a decreased interfacial resistance and the ASSB comprising the anode assembly exhibits an improved cycling performance.

In some embodiments, the slurry further comprises a binder. In some embodiments, the slurry further comprises a solvent.

In some embodiments, the electrolyte layer does not comprise a scaffold layer.

In some embodiments, the interfacial resistance between the electrolyte membrane and the anode is at least 5% lower, at least 7.5% lower, at least 10% lower, at least 12.5% lower, at least 15% lower, at least 17.5% or at least 20% lower than that of one prepared without direct coating.

A cross-section view of the interface between anode layer and SE layer may provide a way to quantify the voids and/or gaps formed therebetween. In some embodiments, the voids along a length of interface between the anode layer and the SE layer is determined by viewing a cross-sectional image taken by a scanning electron microscope (SEM) and identifying and measuring the voids at the interface along the length of the interface. The void percentage at interface can be determined by dividing the sum of the lengths of the voids by the total length of the interface under observation, for example 125 μm. In some embodiments, the void percentage at the interface is determined by measuring at least one, at least two, at least three, at least four, or at least five (or more) sections. In some embodiments, the length of the section of interface can be in a range from 100 μm to 1000 μm, for example 100 μm, 125 μm, 150 μm, 175 μm, 200 μm, 225 μm, 250 μm, 275 μm, 300 μm, 325 μm, 350 μm, 375 μm, 400 μm, 425 μm, 450 μm, 475 μm, 500 μm, 525 μm, 550 μm, 575 μm, 600 μm, 625 μm, 650 μm, 675 μm, 700 μm, 725 μm, 750 μm, 775 μm, 800 μm, 825 μm, 850 μm, 875 μm, 900 μm, 925 μm, 950 μm, 975 μm, or 1,000 μm. In some embodiments, the void percentage at the interface between the anode layer and the SE layer is less than or equal to 10%, less than or equal to 12.5%, less than or equal to 15%, less than or equal to 17.5%, or less than or equal to 20%. In some embodiments, one or more of the sections of interface referred to above are substantially free of voids and/or gaps. In some embodiments, the entire interface between the anode layer and the directly coated SE layer is substantially free of voids and/or gaps. In some embodiments, an interface between the anode layer and the solid electrolyte layer has at least one section that is 125 μm in length that has voids occupying less than or equal to 10% of the interface of the at least one section.

In some embodiments, the solid electrolyte is an oxide-based solid electrolyte or a sulfide-based electrolyte.

In some embodiments, the solid electrolyte has a formula LiₓM1_{y}M2_{z}P₁₋ₚM3ₚS_{6-a-b-q}O_{q}ClₐBr_{b} (Formula I), wherein 4≤x≤8, 0≤y<1, 0≤z<1, 0≤p<1, 0≤q<1, 0≤a≤2, 0≤b<2, 0<6−a−b−q<6, 0<1−p≤1, and wherein M1 is at least one element of Group 1 or Group 11 other than H or Li of the periodic table, M2 is at least one element of Group 2 of the periodic table, and M3 is at least one element of Group 14 of the periodic table.

In some embodiments, M1 is at least one selected from the group consisting of Na, K, Rb, Cs, Cu, Ag, and Au. In some embodiments, M2 is at least one selected from the group consisting of Be, Mg, Ca, Sr, and Ba. In some embodiments, M3 is at least one selected from the group consisting of Si, Ge, Sn, and Pb.

In some embodiments, b/a has a value in a range from 0 to 20, i.e, 0≤b/a≤20.

In some embodiments, the formula of sulfide solid electrolyte in the electrolyte layer, i.e., LiₓM1_{y}M2_{z}P₁₋ₚM3ₚS_{6-a-b-q}O_{q}ClₐBr_{b}, does not comprise any of M1, M2, M3 or O, i.e., y=z=p=q=0, corresponding to a formula of LiₓPS_{6-a-b}ClₐBr_{b}.

In some embodiments, the formula of the sulfide electrolyte comprises at least one element selected from the group consisting of M1, M2, M3 and O. In some embodiments, the Formula (I) contains one element selected from the group consisting of M1, M2, M3 and O. In some embodiments, Formula I is selected from the group consisting of:
1) LiₓM1_{y}PS_{6-a-b}ClₐBr_{b}, where 4≤x≤8, 0<y<1, 0≤a≤2, 0<b<2, 0<6−a−b<6;
2) LiₓM2ₓPS_{6-a-b}ClₐBr_{b}, where 4≤x≤8, 0<z≤1, 0≤a≤2, 0<b<2, 0<6−a−b<6;
3) LiₓP₁₋ₚM3ₚS_{6-a-b}ClₐBr_{b}, where 4<x≤8, 0<p≤1, 0≤a≤2, 0≤b<2, 0<6−a−b<6, 0<1−p<1; and
4) LiₓPS_{6-a-b-q}O_{q}ClₐBr_{b}, where 4≤x≤8, 0<q≤1, 0≤a≤2, 0≤b<2, 0<6−a−b−q<6.

In some embodiments, the Formula (I) contains O and one element selected from the group consisting of M1, M2, and M3. In some embodiments, the sulfide solid electrolyte has a formula selected from the group consisting of LiₓM1_{y}PS_{6-a-b-q}O_{q}ClₐBr_{b} (4≤x≤8, 0<y<10≤q<1, 0≤a≤2, 0≤b<2, 0<6−a−b−q<6), LiₓM2_{z}P₁S_{6-a-b-q}O_{q}ClₐBr_{b} (4≤x≤8, 0<z<1, 0≤q<1, 0≤a≤2, 0<b<2, 0<6−a−b−q<6), and LiₓP₁₋ₚM3ₚS_{6-a-b-q}O_{q}ClₐBr_{b} (4≤x≤8, 0<p<1, 0≤q<1, 0≤a≤2, 0≤b<2, 0<6−a−b−q<6, 0<1−p<1). In one embodiment, the Formula (I) contains O without M1, M2, or M3. In one embodiment, the formula of the sulfide electrolyte is LiₓPS_{6-a-b-q}O_{q}ClₐBr_{b} (4≤x≤8, 0<q<1, 0≤a≤2, 0≤b<2, 0<6−a−b−q<6). In some embodiments, M1 is at least one element of Group 1 or Group 11 other than H or Li of the periodic table. In some embodiments, M1 is at least one selected from the group consisting of Na, K, Rb, Cs, Cu, Ag, and Au. In some embodiments, M2 is at least one element of Group 2 of the periodic table. In some embodiments, M2 is at least one selected from the group consisting of Be, Mg, Ca, Sr, and Ba. In some embodiments, M3 is at least one element of Group 14 of the periodic table. In some embodiments, M3 is at least one selected from the group consisting of Si, Ge, Sn, and Pb.

In one embodiment, the sulfide solid electrolyte has a formula of LiₓPS_{6-a-b-q}O_{q}ClₐBr_{b}, where 4≤x≤8, 0<q≤1, 0≤a≤2, 0≤b<2, 0<6−a−b−q<6. The incorporation of oxygen into the formula makes such material more stable. In some embodiments, the molar amount of O with q having a value in a range from 0 to 0.1, from 0 to 0.2, from 0 to 0.3, from 0 to 0.4, from 0 to 0.5, from 0 to 0.6, from 0.001 to 0.1, from 0.001 to 0.2, from 0.001 to 0.3, from 0.001 to 0.4, from 0.001 to 0.5, from 0.001 to 0.6, from 0.002 to 0.1, from 0.002 to 0.2, from 0.002 to 0.3, from 0.002 to 0.4, from 0.002 to 0.5, from 0.002 to 0.6, from 0.005 to 0.1, from 0.005 to 0.2, from 0.005 to 0.3, from 0.005 to 0.4, from 0.005 to 0.5, from 0.005 to 0.6, or any and all ranges and subranges therebetween. In one embodiment, the formula is Li_{5.8}PS_{4.7}O_{0.1}Cl_{1.2}.

In some embodiments, the formula is LiₓPS_{6-a-b-q}O_{q}ClₐBr_{b}, wherein 4≤x≤8, 0<q≤1, 0≤a≤2, 0<b<2, 0<6−a−b−q<6. In some embodiments, b/a has a value higher than zero. In some embodiments, b/a has a value in a range from 0 to 3.5. In some embodiments, b/a has a value in a range from 0 to 7. In some embodiments, b/a has a value in a range from 0 to 10, from 0 to 15, or from 0 to 20.

In some embodiments, when the formula is LiₓM1_{y}PS_{6-a-b-q}ClₐBr_{b}, 4≤x≤8, 0<y<1, 0≤a≤2, 0≤b<2, 0<6−a−b<6, b/a has a value in a range from 0 to 3.5. In some embodiments, b/a has a value in a range from 0 to 7. In some embodiments, b/a has a value in a range from 0 to 10, from 0 to 15, or from 0 to 20. In some embodiments, b/a has a value higher than zero.

In some embodiments, when the formula is LiₓM2ₓPS_{6-a-b}ClₐBr_{b}, where 4≤x≤8, 0<z≤1, 0≤a≤2, 0≤b<2, 0<6−a−b<6, b/a has a value in a range from 0 to 3.5. In some embodiments, b/a has a value in a range from 0 to 7. In some embodiments, b/a has a value in a range from 0 to 10, from 0 to 15, or from 0 to 20. In some embodiments, b/a has a value higher than zero.

In one embodiment, when the formula is LiₓP₁₋ₚM3ₚS_{6-a-b}ClₐBr_{b}, 4≤x≤8, 0<p≤1, 0≤a≤2, 0≤b<2, 0<6−a−b<6, 0<1−p<1, b/a has a value in a range from 0 to 3.5. In some embodiments, b/a has a value in a range from 0 to 7. In some embodiments, b/a has a value in a range from 0 to 10, from 0 to 15, or from 0 to 20. In some embodiments, b/a has a value higher than zero.

In some embodiments, the Formula (I) contains O and one element selected from the group consisting of M1, M2, and M3. In some embodiments, the sulfide solid electrolyte has a formula selected from the group consisting of LiₓM1_{y}PS_{6-a-b-q}O_{q}ClₐBr_{b} (4≤x≤8, 0<y<1, 0<q<1, 0≤a≤2, 0≤b<2, 0<6−a−b−q<6), LiₓM2_{z}PS_{6-a-b-q}O_{q}ClₐBr_{b} (4≤x≤8, 0<z<1, 0≤q<1, 0≤a≤2, 0≤b<2, 0<6−a−b−q<6), and LiₓP₁₋ₚM3ₚS_{6-a-b-q}O_{q}ClₐBr_{b} (4≤x≤8, 0<p<1, 0<q<1, 0≤a≤2, 0≤b<2, 0<6−a−b−q<6, 0<1−p<1). In one embodiment, the Formula (I) contains O without M1, M2, or M3. In one embodiment, the formula of the sulfide electrolyte is LiₓPS_{6-a-b-q}O_{q}ClₐBr_{b} (4≤x≤8, 0<q<1, 0≤≤2, 0≤b<2, 0<6−a−b−q<6). In some embodiments, the molar amount of Br in the formula has a value higher than zero, i.e., b>0.

In some embodiments, the total molar amount of the halogen in the formula of sulfide electrolyte is no more than 2, i.e., a+b≤2. In one embodiment, the total molar amount of the halogen in the formula is no less than 2 and no more than 3, i.e., 2≤a+b≤3. In one embodiment, the total molar amount of the halogen in the formula is no less than 2 and less than 4, i.e., 2≤a+b<4. In one embodiment, the total molar amount of Br and Cl in the formula is no more than 2, i.e., a+b≤2, no less than 2 and no more than 3, i.e., 2≤a+b≤3, or no less than 2 and less than 4, i.e., 2≤a+b<4.

In some embodiments, the sulfide solid electrolyte has a formula selected from the group consisting of:
1) LiₓPS_{6-a-b}ClₐBr_{b}, where 4≤x≤8, 0≤a≤2, 0≤b<2, 0<6−a−b<6;
2) LiₓM1_{y}PS_{6-a-b}ClₐBr_{b}, where 4<x<8, 0<y<1, 0≤a≤2, 0≤b<2, 0<6−a−b<6;
3) LiₓM2ₓPS_{6-a-b}ClₐBr_{b}, where 4≤x≤8, 0<z<1, 0≤a≤2, 0≤b<2, 0<6−a−b<6;
4) LiₓP₁₋ₚM3ₚS_{6-a-b}ClₐBr_{b}, where 4≤x≤8, 0<p<1, 0≤a≤2, 0≤b<2, 0<6−a−b<6, 0<1−p<1;
5) LiₓPS_{6-a-b-q}O_{q}ClₐBr_{b}, where 4≤x≤8, 0<q≤1, 0≤a≤2, 0≤b<2, 0<6−a−b−q<6;
6) LiₓM1_{y}PS_{6-a-b-q}O_{q}ClₐBr_{b}, where 4≤x≤8, 0<y<1, 0<q<1, 0≤a≤2, 0≤b<2, 0<6−a−b−q<6;
7) LiₓM2ₓPS_{6-a-b-q}O_{q}ClₐBr_{b}, where 4≤x≤8, 0<z<1, 0≤q<1, 0≤a≤2, 0≤b<2, 0<6−a−b−q<6;
8) LiₓP₁₋ₚM3ₚS_{6-a-b-q}O_{q}ClₐBr_{b}, where 4≤x≤8, 0<p<1, 0<q<1, 0≤a≤2, 0≤b<2, 0<6−a−b−q<6, 0<1−p<1; and
9) mixtures thereof.

In some embodiments, the sulfide solid electrolyte has a formula selected from the group consisting of: Li_{5.8}PS_{4.7}O_{0.1}Cl_{1.2}, Li_{5.9}P_{0.9}Ge_{0.1}S_{4.8}Cl_{1.2}, Li_{5.7}Na_{0.1}PS_{4.8}Cl_{1.2}, Li_{5.4}PS_{4.4}Cl_{0.4}Br_{1.2}, Li_{5.8}PS_{4.8}Cl_{0.4}Br_{0.8}, Li_{5.4}PS_{4.4}Cl_{0.6}Br_{1.0}, Li_{5.4}PS_{4.4}Cl_{0.8}Br_{0.8}, Li_{5.4}PS_{4.4}Cl_{0.8}Br_{0.8}, Li_{5.8}PS_{4.8}Cl_{0.6}Br_{0.6}, Li_{5.4}PS_{4.4}Cl_{1.0}Br_{0.6}, Li_{5.4}PS_{4.4}Cl_{1.2}Br_{0.4}, Li_{5.8}PS_{4.8}Cl_{0.8}Br_{0.4}, Li_{5.8}PS_{4.8}Cl_{1.0}Br_{0.2}, Li_{5.4}PS_{4.4}Cl_{1.4}Br_{0.2} and mixtures thereof.

In some embodiments, the sulfide electrolyte in the electrolyte layer as disclosed herein has a cubic crystal structure. In some embodiments, the sulfide electrolyte has a crystal structure in the F4̅3m space group as verified by XRD. In some embodiments, the solid electrolyte is a sulfide solid electrolyte having an argyrodite crystal structure. In some embodiments, the sulfide solid electrolyte has an argyrodite crystal structure with three peaks at 2θ=25.8±0.3, 30.3±0.4 and 31.7±0.4 in X-ray diffractometry using a CuKα ray.

In some embodiments, the electrolyte layer directly coated on the anode layer has a thickness in a range from 5 μm to 300 μm, from 10 μm to 300 μm, from 20 μm to 300 μm, from 50 μm to 300 μm, from 2 μm to 500 μm, from 5 μm to 500 μm, from 10 μm to 500 μm, from 10 μm to 500 μm, from 20 μm to 500 μm, from 50 μm to 500 μm, or any and all ranges and subranges therebetween.

In some embodiments, the electrolyte layer in the anode assembly has a lithium-ion conductivity of no less than 0.05 mS/cm, no less than 0.1 mS/cm, no less than 0.2 mS/cm, no less than 0.5 mS/cm, no less than 0.75 mS/cm, no less than 1 mS/cm, no less than 2 mS/cm, or no less than 5 mS/cm, no less than 7.5 mS/cm or no less than 10 mS/cm. In some embodiments, the electrolyte layer has a lithium-ion conductivity in a range from 0.05 mS/cm to 10 mS/cm, from 0.1 mS/cm to 10 mS/cm, from 0.25 mS/cm to 10 mS/cm, from 0.5 mS/cm to 10 mS/cm, from 0.75 mS/cm to 10 mS/cm, from 1 mS/cm to 10 mS/cm, from 2 mS/cm to 10 mS/cm, from 0.05 mS/cm to 7.5 mS/cm, from 0.1 mS/cm to 7.5 mS/cm, from 0.25 mS/cm to 7.5 mS/cm, from 0.5 mS/cm to 7.5 mS/cm, from 0.75 mS/cm to 7.5 mS/cm, from 1 mS/cm to 7.5 mS/cm, from 2 mS/cm to 7.5 mS/cm, from 0.05 mS/cm to 5 mS/cm, from 0.1 mS/cm to 5 mS/cm, from 0.25 mS/cm to 5 mS/cm, from 0.5 mS/cm to 5 mS/cm, from 0.75 mS/cm to 5 mS/cm, from 1 mS/cm to 5 mS/cm, or any and all ranges and subranges therebetween.

In some embodiments, the binder is a nonfibrillizable binder. In some embodiments, the binder has a weight percentage in a range from 1.0 wt % to 10.0 wt % in the electrolyte layer. In some embodiments, the binder is made of a material selected from the group consisting of polyacrylate, styrene-butadiene rubber (SBR), poly(vinylidene fluoride) (PVDF), vinylidene fluoride/hexafluoropropylene copolymer, polyvinylidene fluoride-co-trichloroethylene, polyacrylonitrile, polymethylmethacrylate, polyvinylpyrrolidone, polyvinylacetate, polyethylene-co-vinyl acetate, polyethylene oxide, arylate copolymer, cellulose acetate, cellulose acetate butyrate, cellulose acetate propionate, polysaccharide polymer and carboxyl methyl cellulose, or a combination thereof.

In some embodiments, the binder is homogeneously dispersed in the SE layer.

In one aspect, the present disclosure provides an electrochemical device such as an ASSB comprising the anode assembly as described herein.

In some embodiments, the ASSB exhibits a capacity retention rate of at least 90%, at least 91%, at least 92%, at least 93%, at least 94%, at least 95%, at least 96%, at least 97%, at least 98%, or at least 99% after at least 300 cycles at a rate of C/3 at 45° C. In some embodiments, the cycling test can be performed at other C rates such as C/6, C/4, C/2, C, 1 C, 2 C, 3 C, 5 C, or any intermediate rate therebetween. In some embodiments, the cycling test can be performed at other temperatures such as −20° C., −10° C., 0° C., 10° C., 20° C. 25° C., 30° C., 40° C., 50° C., 80° C., or any intermediate temperature therebetween. Cycle life is determined by the number of cycles for the battery cell to reach 80% of its original capacity and is usually used to measure the cycling performance of a secondary battery. In some embodiments, the ASSB comprising the anode assembly exhibits a cycle life which is at least 10%, at least 15%, at least 20%, at least 25%, at least 30%, at least 40%, at least 50%, or at least 60% longer than that of the ones prepared without direct coating.

In some embodiments, a cathode in an ASSB comprises a cathode active material layer and cathode current collector. In one embodiment, a cathode active material layer comprises a cathode active material (CAM). In some embodiments, the cathode active material layer is a composite layer and comprises a cathode active material, an ionic conductor such as solid electrolyte, and a carbonaceous material such as carbon black or carbon fiber. In some embodiments, the carbonaceous material in cathode active material layer comprises at least one selected from the group consisting of carbon black, acetylene black, Ketjen black, channel black, furnace black, lamp black, thermal black, natural graphite and artificial graphite.

In one embodiment, the cathode active material shows a redox reaction at a potential of 2 V or more on a lithium electrode basis during operation of the ASSB.

In one embodiment, the cathode active material contains at least Li, Ni, and Co. In one embodiment, the cathode active material contains Li, Ni, and Co and at least one of Mn and Al. In one embodiment, the cathode active material contains at least one of Fe, and P.

In some embodiments, the anode layer in the anode assembly contains an anode active material. In some embodiments, the anode active material includes a carbon-based conductive material with at least one selected from the group consisting of carbon black, acetylene black, Ketjen black, channel black, furnace black, lamp black, thermal black, natural graphite and artificial graphite.

In some embodiments, an anode active material layer of an anode layer comprises an anode active material such as lithium metal or a lithium alloy. In some embodiments, the anode active material comprises at least one selected from the group consisting of lithium, sodium, magnesium, aluminum, silicon, calcium, titanium, manganese, iron, cobalt, nickel, zinc, molybdenum, silver, indium, tin, and tungsten. In some embodiments, the anode layer comprises an anode active material layer and the slurry is directly coated to the anode active material layer. In some embodiments, the anode layer further comprises an anode current collector, the slurry is coated to the anode current collector and an anode active material layer is formed after the first charge. In some embodiments, the anode layer comprises an anode active material layer before the first charge and the slurry is directly coated to the anode active material layer.

In some embodiments, the anode layer comprises an anode active material layer and an anode protective layer. In some embodiments, the anode protective layer is made of a composite comprising a carbonaceous material and a metal alloyable with lithium. In some embodiments, the carbonaceous material is at least one selected from the group consisting of carbon black, acetylene black, Ketjen black, channel black, furnace black, lamp black, thermal black, natural graphite and artificial graphite. In some embodiments, the metal is at least one selected from the group consisting of Ag, Zn, Ti, Cd, Mg, Al, Ga, Si, Ge, In, Sn, Pb, Bi, and Sb. In some embodiments, the anode protective layer has a thickness in a range from 0.1 μm to 50 μm. In some embodiments, the carbonaceous material has a volume percentage in a range from 50% to 90%. In some embodiments, the metal has a volume percentage in a range from 10% to 50%. In some embodiments, the metal exists as nanoparticles with a median particle size (D50) in a range from 20 nm to 80 nm in the composite or the composite layer. In some embodiments, the composite further comprises a second metal that is not alloyable with lithium. In some embodiments, the second metal is at least one selected from the group consisting of Cu, Mo, Ir, W, Co, Ni, Ru, Fe, Se, Ta, Nb, V, and Zr.

In some embodiments, the slurry is applied to the anode protective layer of an anode layer.

In some embodiments, the ASSB comprising the anode assembly exhibits a cycling life of at least 10% higher, at least 15% higher, at least 20% higher, at least 25% higher, at least 30% higher, at least 35% higher, at least 40% higher, at least 45% higher, or at least 50% higher than that of one comprising an electrolyte layer prepared without direct coating.

In some embodiments, the ASSB exhibits an impedance at an open circuit voltage (OCV) of at least 5% lower, at least 6% lower, at least 7% lower, at least 8% lower, at least 9% lower, at least 10% lower, at least 12.5% lower, at least 15% lower, at least 17.5% lower, at least 20% lower, at least 25% lower, at least 30% lower, at least 35% lower, at least 40% lower, or at least 45% lower than that of one comprising an SE layer prepared without direct coating.

In some embodiments, the ASSB exhibits a coulombic efficiency of at least 90%, at least 92%, at least 94%, at least 96%, at least 98% or at least 99% after 300 cycles at a rate of C/3 at 45° C.

In one aspect, the present disclosure provides a method of preparing an anode assembly. The method may comprise:
1) mixing a binder, a solvent, and particles of a sulfide electrolyte to form a slurry;
2) coating the slurry on an anode layer; and
3) removing the solvent from the slurry coated on the anode layer, thereby obtaining an anode assembly comprising an electrolyte layer directly coated on the anode layer.

In some embodiments, the solvent has a weight percentage in a range from 25% to 75%, from 25% to 70%, from 25% to 65%, from 25% to 60%, from 25% to 55%, from 25% to 50%, from 25% to 45%, from 25% to 40%, from 30% to 75%, from 30% to 70%, from 30% to 65%, from 30% to 60%, from 30% to 55%, from 30% to 50%, from 30% to 45%, from 30% to 40%, from 35% to 75%, from 35% to 70%, from 35% to 65%, from 35% to 60%, from 35% to 55%, from 35% to 50%, from 35% to 45%, or all and any ranges and subranges therebetween in the slurry.

In one embodiment, the particles of the sulfide electrolyte, the binder and the solvent are mixed in a planetary centrifugal mixer.

In one embodiment, the anode layer comprises an anode protective layer as disclosed in the present disclosure. In one embodiment, the slurry is applied to the anode protective layer.

In some embodiments, the solvent is selected from the group consisting of comprises xylene, isobutyl isobutyrate and a mixture thereof. In some embodiments, the solvent is removed by drying, vacuum or a combination thereof.

In one aspect, the present disclosure provides an anode assembly prepared according to a method as described herein.

The disclosure will be better understood by reference to the Experimental Details which follow, but those skilled in the art will readily appreciate that the specific experiments detailed are only illustrative, and are not meant to limit the disclosure as described herein, as numerous variations and modifications of these exemplary embodiments are possible without undue experimentation. All such variations and modifications are within the scope of the teachings of this disclosure. It will be appreciated that the foregoing description and following examples, no matter how detailed they may appear in text, the disclosure may be practiced in many ways, and the disclosure should be construed in accordance with the appended claims and equivalents thereof.

### Example 1

### Synthesis of Solid Electrolyte Materials

In a glove box having an inert Ar atmosphere, raw precursor powders were prepared at a stoichiometric ratio. The precursor examples include, but are not limited to, Li₂S, Na₂S, P₂S₅, LiCl, LiBr, Li₂O, GeS₂, or combinations thereof. These powders were ball milled planetary ball miller for 4 hours. Subsequently, these powders were sintered at 450° C. for 12 hours.

Thereby, solid electrolyte materials with argyrodite-type structure were obtained. After a grinding procedure, solid electrolyte particles have an average particle size in a range from 1 to 10 μm and will be used for slurry preparation.

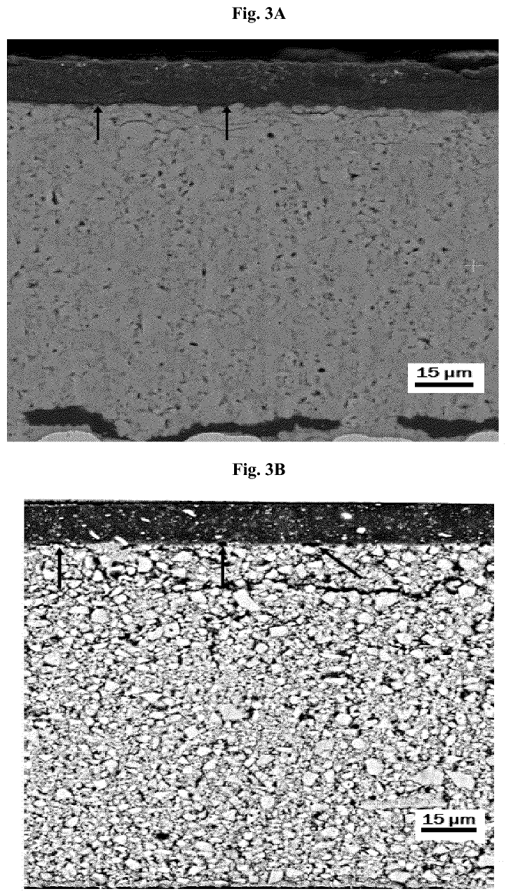

X-ray diffraction (XRD) measurement of SE particles was performed using an X-ray diffractometer (SmartLab, Rigaku) with Cu-Kα radiation. Diffraction data were collected in steps of 0.05° over a 2θ range of 5-60° at a scan rate of 3° min⁻¹. XRD measurements were performed using an airtight container to prevent air exposure to the electrolyte powder. FIG. 2 shows XRD patterns of representative sulfide electrolytes. The sulfide electrolytes have a cubic crystal structure.

### Preparation of Anode Assembly

Particles of the above sulfide electrolyte with a formula of Li_{5.4}PS_{4.4}Cl_{0.2}Br_{1.4} were mixed with an acrylate binder and isobutyl isobutyrate as solvent, resulting in a slurry. The slurry was applied to a surface of an anode layer followed by a drying, leading to an anode assembly comprising an anode layer and a solid sulfide electrolyte layer directly coating on the anode layer.

Two (2) comparative electrolyte layers were prepared. The electrolyte layer of comparative example 1 (Comp. Ex. 1) was prepared by coating the slurry to a base with a scaffold layer such as non-woven fabric followed by peeling the dried coating from the base after removal of the solvent. After peeling, the scaffold layer was attached and/or bonded to the electrolyte layer as the slurry impregnated pores of the scaffold layer. The electrolyte layer of comparative example 2 (Comp. Ex. 2) was prepared by following the method above of Comp. Ex. 1 except that no scaffold layer was used. After peeling, the electrolyte layer of comparative example 2 did not include nor was attached to any scaffold layer and was a free-standing electrolyte layer.

For the measurement of lithium-ion conductivity: SE layers of the two (2) comparative electrolyte layers were first punched into a disc with diameter of 1.2 cm and pressed in a torque cell (PEEK) with stacking pressure of 375 MPa. Titanium plungers were used as current collectors. Ionic conductivities of solid electrolyte membrane were measured by electrochemical impedance spectroscopy (EIS) were collected in the range from 1 Hz to 7 MHz using a potentiostat (SP200, Biologic) with an applied AC voltage of 10 mV. All measurements were performed at room temperature unless otherwise specified. When an SE layer is prepared with a non-woven fabric as scaffold layer, the SE layers with a formula of Li_{5.4}PS_{4.4}Cl_{1.6} and Li_{5.4}PS_{4.4}C_{1.2}Br_{0.4} exhibit a lithium-ion conductivity of 1.37 mS/cm and 0.97 mS/cm, respectively. Free-standing SE layers of Li_{5.4}PS_{4.4}Cl_{1.6}, and Li_{5.4}PS_{4.4}C_{1.2}Br_{0.4} exhibit a lithium-ion conductivity of 2.06 mS/cm and 1.80 mS/cm, respectively. As the SE layer in the anode assembly is firmly attached or bonded to the anode layer, it is challenging to separate the SE layer from the anode layer. Since the SE layer directly coated on anode layer and the free-standing SE layer share the same composition, the SE layer in the anode assembly was expected to exhibit a lithium-ion conductivity similar to that of the free-standing SE layer. In some embodiments, the SE layer in the anode assembly may exhibit a lithium-ion conductivity higher than that of the free-standing SE layer since the SE layer prepared by direct coating does not experience any peeling procedure, which may introduce structural defects that deteriorate the conductivity.

### Assembly of Cells and Testing

Cells comprising a cathode, the anode assembly as prepared above (or an anode layer and a comparative electrolyte layer above) were assembled and sealed in a pouch followed by an isostatic pressing.

### Characterizations of SE/Anode Interface

A scanning electron microscopy (SEM) was conducted on a cross-section of the anode assembly or an anode layer laminated on an SE layer.

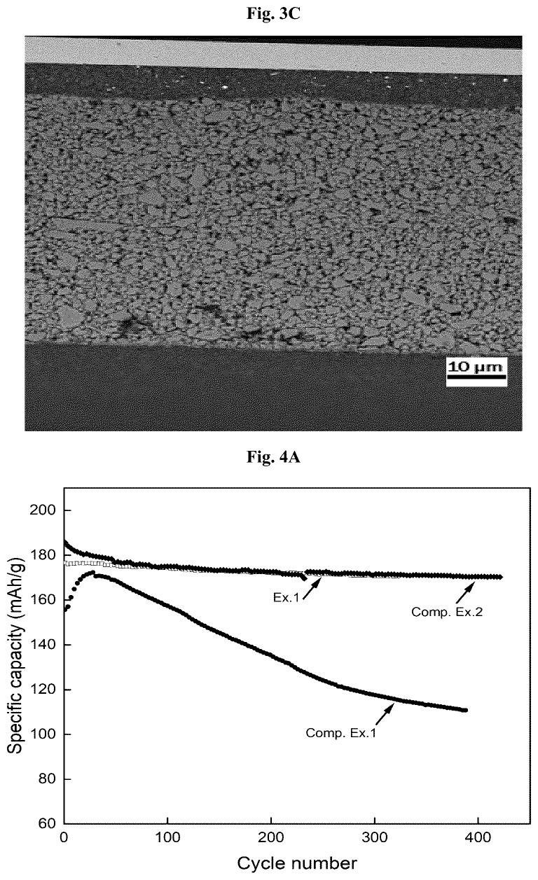

FIGS. 3A through 3C are the SEM images of an anode layer on the electrolyte layer of comparative example 1 (Comp. Ex. 1), an anode layer on the electrolyte layer of comparative example 2 (Comp. Ex. 2), and the anode assembly prepared by direct coating (Ex. 1), respectively. As shown in FIG. 3A, the interface between the anode layer and the SE layer with non-woven fabric is partially occupied by voids and gaps as indicated by the arrows. The interface under observation has a length of around 125 μm while around 61 μm (50%) of the interface is occupied by the voids and gaps. As shown in FIG. 3B, the interface under observation has a length of around 125 μm while around 33 μm (around 25%) of the interface is occupied by the voids and gaps. In contrast, as shown in FIG. 3C, the interface between the anode layer and a directly coated SE layer is substantially free of voids and gaps.

The impedance was measured using Hioki 3560 AC mOhm Hitester at a frequency of 1000 Hz at the open circuit voltage (OCV) at room temperature. The impedance of full cells is shown in Table 1. It shows that the full cell comprising the anode assembly prepared by direct coating exhibits an impedance which is 7.32% lower than the comparative example cell, which comprises an SE with non-woven fabric as scaffold layer.

TABLE 1
Impedance of full cells at open circuit voltage (OCV)

| | Comparative example - | | |
|---|---|---|---|
| | SE with non-woven | Anode Assembly | In comparison |
| | fabric and without | prepared by | to comparative |
| | direct coating | direct Coating | example |
| Impedance | 1.64 | 1.52 | 7.32% ↓ |
| (ohm) | | | |

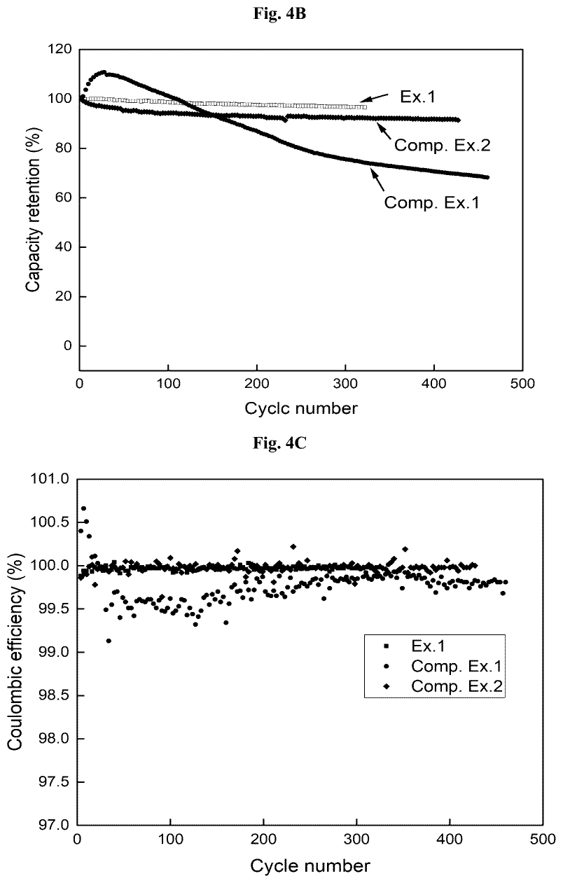

Cycling testing of the cells was conducted at 45° C., wherein each cycle charges to 4.25 V and discharges to 2.8V at a rate of C/3. After 322 cycles, as shown in FIGS. 4A and 4B, the cell comprising the anode assembly (Example 1) exhibits a specific capacity of 170 mAh/g and a capacity retention rate of 96.5%. The cells comprising the comparative electrolyte layers, exhibits a less desirable cycling performance. After 390 cycles, the cell comprising the electrolyte layer of comparative example 1 (Comp. Ex. 1) exhibits a specific capacity of 110.5 mAh/g and a capacity retention rate of 71%. After 423 cycles, the cell comprising the electrolyte layer of comparative example 2 (Comp. Ex. 2) exhibits a specific capacity of 170 mAh/g and a capacity retention rate of 91.7%. As shown in FIG. 4C, the coulombic efficiency (CE) of example 1 is consistently high and close to 100% while the comparative examples 1 and 2 have a lower CE with less consistency.

### Aspects

In a first aspect, the present disclosure provides an anode assembly comprising an anode layer and a solid electrolyte layer on the anode layer, wherein the solid electrolyte layer comprises a sulfide solid electrolyte and a binder, wherein the solid electrolyte layer is coated to the anode layer by directly coating a slurry on the anode layer followed by drying, and wherein, an interface between the anode layer and the solid electrolyte layer has at least one section that is 125 μm in length that has voids occupying less than or equal to 10% of the interface of the at least one section under a cross-section view.

In some embodiments, the anode layer comprises an anode protective layer (alternatively, anode sublayer or anode interlayer) and an anode active material layer. In some embodiments, the anode layer comprises an anode protective layer without any anode active material layer. In some embodiments, the SE layer is in direct contact with the anode protective layer. In some embodiments, the anode layer comprises an anode active material layer without any anode protective layer, wherein the SE layer is in direct contact with the anode active material layer.

In a second aspect according to the first aspect, the solid electrolyte layer does not comprise a scaffold layer.

In a third aspect according to the first or second aspect, the interfacial resistance between the SE layer and the anode is at least 10% lower than that of one prepared without direct coating.

In a fourth aspect according to any preceding aspect, the binder is a nonfibrillizable binder and has a weight percentage in a range from 1.0 wt % to 10.0 wt % in the SE layer.

In a fifth aspect according to any preceding aspect, the sulfide solid electrolyte has a formula LiₓM1_{y}M2_{z}P₁₋ₚM3ₚS_{6-a-b-q}O_{q}ClₐBr_{b} (Formula I), wherein 4≤x≤8, 0≤y<1, 0≤z<1, 0≤p<1, 0≤q<1, 0≤a≤2, 0≤b<2, 0<6−a−b−q<6, 0<1−p<1, and wherein M1 is at least one element of Group 1 or Group 11 other than H or Li of the periodic table, M2 is at least one element of Group 2 of the periodic table, and M3 is at least one element of Group 14 of the periodic table.

In a sixth aspect according to the fifth aspect, 0≤b/a≤20.

In a seventh aspect according to any preceding aspect, the electrolyte layer has a lithium-ion conductivity of at least 10% of that of a powder of the sulfide solid electrolyte.

In an eighth aspect according to any preceding aspect, the electrolyte layer has a lithium-ion conductivity in a range from 0.05 to 20 mS/cm.

In a ninth aspect according to any preceding aspect, the binder is a nonfibrillizable binder and comprises a material selected from the group consisting of polyacrylate, styrene-butadiene rubber (SBR), poly(vinylidene fluoride) (PVDF), vinylidene fluoride/hexafluoropropylene copolymer, polyvinylidene fluoride-co-trichloroethylene, polyacrylonitrile, polymethylmethacrylate, polyvinylpyrrolidone, polyvinylacetate, polyethylene-co-vinyl acetate, polyethylene oxide, arylate copolymer, cellulose acetate, cellulose acetate butyrate, cellulose acetate propionate, polysaccharide polymer and carboxyl methyl cellulose, and mixtures thereof.

In a tenth aspect according to any preceding aspect, the binder is homogeneously dispersed in the SE layer.

In an eleventh aspect according to any preceding aspect, the SE layer has a thickness in a range from 5 μm to 300 μm.

In a twelfth aspect according to any preceding aspect, the sulfide solid electrolyte has a formula selected from the group consisting of:
1) LiₓPS_{6-a-b}ClₐBr_{b}, where 4≤x≤8, 0≤a≤2, 0≤b<2, 0<6−a−b<6;
2) LiₓM1_{y}PS_{6-a-b}ClₐBr_{b}, where 4<x<8, 0<y<1, 0≤a≤2, 0≤b<2, 0<6−a−b<6;
3) LiₓM2ₓPS_{6-a-b}ClₐBr_{b}, where 4≤x≤8, 0<z<1, 0≤a≤2, 0≤b<2, 0<6−a−b<6;
4) LiₓP₁₋ₚM3ₚS_{6-a-b}ClₐBr_{b}, where 4≤x≤8, 0<p<1, 0≤a≤2, 0≤b<2, 0<6−a−b<6, 0<1−p<1;
5) LiₓPS_{6-a-b-q}O_{q}ClₐBr_{b}, where 4≤x≤8, 0<q≤1, 0≤a≤2, 0≤b<2, 0<6−a−b−q<6;
6) LiₓM1_{y}PS_{6-a-b-q}O_{q}ClₐBr_{b}, where 4≤x≤8, 0<y<1, 0<q<1, 0≤a≤2, 0≤b<2, 0<6−a−b−q<6;
7) LiₓM2ₓPS_{6-a-b-q}O_{q}ClₐBr_{b}, where 4≤x≤8, 0<z<1, 0≤q<1, 0≤a≤2, 0≤b<2, 0<6−a−b−q<6;
8) LiₓP₁₋ₚM3ₚS_{6-a-b-q}O_{q}ClₐBr_{b}, where 4≤x≤8, 0<p<1, 0<q<1, 0≤a≤2, 0≤b<2, 0<6−a−b−q<6, 0<1−p<1; and
9) mixtures thereof.

In a thirteenth aspect according to any preceding aspect, the sulfide SE has a formula selected from the group consisting of: Li_{5.8}PS_{4.7}O_{0.1}Cl_{1.2}, Li_{5.9}P_{0.9}Ge_{0.1}S_{4.8}Cl_{1.2}, Li_{5.7}Na_{0.1}PS_{4.8}Cl_{1.2}, Li_{5.4}PS_{4.4}Cl_{0.4}Br_{1.2}, Li_{5.8}PS_{4.8}Cl_{0.4}Br_{0.8}, Li_{5.4}PS_{4.4}Cl_{0.6}Br_{1.0}, Li_{5.4}PS_{4.4}Cl_{0.8}Br_{0.8}, Li_{5.4}PS_{4.4}Cl_{0.8}Br_{0.8}, Li_{5.8}PS_{4.8}Cl_{0.6}Br_{0.6}, Li_{5.4}PS_{4.4}Cl_{1.0}Br_{0.6}, Li_{5.4}PS_{4.4}Cl_{1.2}Br_{0.4}, Li_{5.8}PS_{4.8}Cl_{0.8} Br_{0.4}, Li_{5.8}PS_{4.8}Cl_{1.0}Br_{0.2}, and Li_{5.4}PS_{4.4}Cl_{1.4}Br_{0.2}, and mixtures thereof.

In a fourteenth aspect according to any preceding aspect, the sulfide solid electrolyte has an argyrodite crystal structure.

In a fifteenth aspect according to any preceding aspect, the sulfide solid electrolyte has an argyrodite crystal structure with three peaks at 2θ=25.8±0.3, 30.3±0.4 and 31.7±0.4 in X-ray diffractometry using a CuKα ray.

In a sixteenth aspect according to any preceding aspect, the anode layer comprises an anode protective layer comprising a carbonaceous material and a metal alloyable with lithium, wherein the slurry is applied to the anode protective layer.

In a seventeenth aspect according to the sixteenth aspect, the metal alloyable with lithium is selected from the group consisting of Ag, Zn, Ti, Cd, Mg, Al, Ga, Si, Ge, In, Sn, Pb, Bi, and Sb.

In an eighteenth aspect according to the sixteenth or seventeenth aspect, the anode protective layer further comprises a second metal that is not alloyable with lithium.

In a nineteenth aspect, the second metal is selected from the group consisting of Cu, Mo, Ir, W, Co, Ni, Ru, Fe, Se, Ta, Nb, V, and Zr.

In a twentieth aspect, the present disclosure provides an ASSB comprising the anode assembly of any preceding aspect.

In a twenty-first aspect according to the twentieth aspect, the ASSB exhibits a capacity retention rate of at least 90% after 300 cycles at a rate of C/3 at 45° C.

In a twenty-second aspect according to the twentieth or twenty-first aspect, the ASSB exhibits a cycling life of at least 10% higher than that of one comprising an electrolyte layer prepared without direct coating.

In a twenty-third aspect according to any of the twentieth through twenty-second aspects, the ASSB exhibits an impedance at OCV of at least 7.0% lower than that of one comprising an electrolyte layer prepared without direct coating.

In a twenty-fourth aspect according to any of the twentieth through twenty-third aspects, the ASSB exhibits a coulombic efficiency of at least 90% after at least 300 cycles at a rate of C/3 at 45° C.

In a twenty-fifth aspect, the present disclosure provides a method of preparing an anode assembly, comprising:
1) mixing a binder such as nonfibrillizable binder, a solvent, and particles of a sulfide electrolyte to form a slurry;
2) coating the slurry on an anode layer; and
3) removing the solvent from the slurry coated on the anode layer, thereby obtaining an anode assembly comprising a solid electrolyte layer directly coated on the anode layer.

In a twenty-sixth aspect according to the twenty-fifth aspect, the solvent has a weight percentage in a range from 25% to 65% in the slurry.

In a twenty-seventh aspect according to the twenty-fifth or twenty-sixth aspect, the solvent is selected from the group consisting of comprises xylene, isobutyl isobutyrate and mixtures thereof.

In a twenty-eighth aspect according to any of the twenty-fifth through twenty-seventh aspects, the solvent is removed by drying, vacuum or a combination thereof.

In a twenty-ninth aspect according to any of the twenty-fifth through twenty-eighth aspects, the anode layer comprises an anode protective layer and the slurry is applied to the anode protective layer.

In a thirtieth aspect, the present disclosure provides an anode assembly prepared according to the method as disclosed herein,

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternative to the specific embodiments described herein are also within the scope of this disclosure.

What is claimed is:

1. An anode assembly comprising:
a) an anode layer; and
b) a solid electrolyte layer on the anode layer, wherein the solid electrolyte layer comprises a sulfide solid electrolyte and a binder,
wherein the solid electrolyte layer is coated to the anode layer by directly coating a slurry on the anode layer followed by drying, and
wherein, an interface between the anode layer and the solid electrolyte layer has at least one section that is 125 μm in length that has voids occupying less than or equal to 10% of the interface of the at least one section under a cross-section view.

2. The anode assembly of claim 1, wherein the solid electrolyte layer does not comprise a scaffold layer.

3. The anode assembly of claim 1, wherein the interfacial resistance between the solid electrolyte layer and the anode is at least 10% lower than that of one prepared without direct coating.

4. The anode assembly of claim 1, where the binder is a nonfibrillizable binder and has a weight percentage in a range from 1.0 wt % to 10.0 wt % in the electrolyte layer.

5. The anode assembly of claim 1, wherein the electrolyte layer has a lithium-ion conductivity in a range from 0.05 to 20 mS/cm.

6. The anode assembly of claim 1, wherein the sulfide solid electrolyte has a formula selected from the group consisting of:
1) LiₓPS_{6-a-b}ClₐBr_{b}, where 4≤x≤8, 0≤a≤2, 0≤b<2, 0<6−a−b<6;
2) LiₓM1_{y}PS_{6-a-b}ClₐBr_{b}, where 4<x<8, 0<y<1, 0≤a≤2, 0≤b<2, 0<6−a−b<6;
3) LiₓM2ₓPS_{6-a-b}ClₐBr_{b}, where 4≤x≤8, 0<z<1, 0≤a≤2, 0≤b<2, 0<6−a−b<6;
4) LiₓP₁₋ₚM3ₚS_{6-a-b}ClₐBr_{b}, where 4≤x≤8, 0<p<1, 0≤a≤2, 0≤b<2, 0<6−a−b<6, 0<1−p<1;
5) LiₓPS_{6-a-b-q}O_{q}ClₐBr_{b}, where 4≤x≤8, 0<q≤1, 0≤a≤2, 0≤b<2, 0<6−a−b−q<6;
6) LiₓM1_{y}PS_{6-a-b-q}O_{q}ClₐBr_{b}, where 4≤x≤8, 0<y<1, 0<q<1, 0≤a≤2, 0≤b<2, 0<6−a−b−q<6;
7) LiₓM2ₓPS_{6-a-b-q}O_{q}ClₐBr_{b}, where 4≤x≤8, 0<z<1, 0≤q<1, 0≤a≤2, 0≤b<2, 0<6−a−b−q<6;
8) LiₓP₁₋ₚM3ₚS_{6-a-b-q}O_{q}ClₐBr_{b}, where 4≤x≤8, 0<p<1, 0<q<1, 0≤a≤2, 0≤b<2, 0<6−a−b−q<6, 0<1−p<1; and
9) mixtures thereof.

7. The anode assembly of claim 1, wherein the sulfide solid electrolyte has a formula selected from the group consisting of: Li_{5.8}PS_{4.7}O_{0.1}Cl_{1.2}, Li_{5.9}P_{0.9}Ge_{0.1}S_{4.8}Cl_{1.2}, Li_{5.7}Na_{0.1}PS_{4.8}Cl_{1.2}, Li_{5.4}PS_{4.4}Cl_{0.4}Br_{1.2}, Li_{5.8}PS_{4.8}Cl_{0.4}Br_{0.8}, Li_{5.4}PS_{4.4}Cl_{0.6}Br_{1.0}, Li_{5.4}PS_{4.4}Cl_{0.8}Br_{0.8}, Li_{5.4}PS_{4.4}Cl_{0.8}Br_{0.8}, Li_{5.8}PS_{4.8}Cl_{0.6}Br_{0.6}, Li_{5.4}PS_{4.4}Cl_{1.0}Br_{0.6}, Li_{5.4}PS_{4.4}Cl_{1.2}Br_{0.4}, Li_{5.8}PS_{4.8}Cl_{0.8}Br_{0.4}, Li_{5.8}PS_{4.8}Cl_{1.0}Br_{0.2}, and Li_{5.4}PS_{4.4}Cl_{1.4}Br_{0.2}, and mixtures thereof.

8. The anode assembly of claim 1, wherein the sulfide solid electrolyte has an argyrodite crystal structure.

9. The anode assembly of claim 1, wherein the sulfide solid electrolyte has an argyrodite crystal structure with three peaks at 2θ=25.8±0.3, 30.3±0.4 and 31.7±0.4 in X-ray diffractometry using a CuKα ray.

10. The anode assembly of claim 1, wherein the anode layer comprises an anode protective layer comprising a carbonaceous material and a metal alloyable with lithium, wherein the slurry is applied to the anode protective layer.

11. The anode assembly of claim 10, wherein the metal is selected from the group consisting of Ag, Zn, Ti, Cd, Mg, Al, Ga, Si, Ge, In, Sn, Pb, Bi, and Sb.

12. The anode assembly of claim 10, wherein the anode protective layer further comprises a second metal that is not alloyable with lithium.

13. The anode assembly of claim 12, wherein the second metal is selected from the group consisting of Cu, Mo, Ir, W, Co, Ni, Ru, Fe, Se, Ta, Nb, V, and Zr.

14. An all solid-state battery (ASSB) comprising the anode assembly of claim 1.

15. The ASSB of claim 14, wherein the ASSB exhibits a capacity retention rate of at least 90% after 300 cycles at a rate of C/3 at 45° C.

16. The ASSB of claim 14, wherein the ASSB exhibits a cycling life of at least 10% higher than that of one comprising an electrolyte layer prepared without direct coating.

17. The ASSB of claim 14, wherein the ASSB exhibits a coulombic efficiency of at least 90% after at least 300 cycles at a rate of C/3 at 45° C.

18. A method of preparing an anode assembly, comprising:
1) mixing a nonfibrillizable binder, a solvent, and particles of a sulfide electrolyte to form a slurry;
2) coating the slurry on an anode layer; and
3) removing the solvent from the slurry coated on the anode layer, thereby obtaining an anode assembly comprising a solid electrolyte layer directly coated on the anode layer.

19. The method of claim 18, wherein the solvent is selected from the group consisting of comprises xylene, isobutyl isobutyrate and mixtures thereof and the solvent has a weight percentage in a range from 25% to 65% in the slurry.

20. The method of claim 18, wherein the anode layer comprises an anode protective layer and the slurry is applied to the anode protective layer of the anode layer.
